(19) United States
(12) Patent Application Publication
(10) Pub. No.: US 2011/0083540 A1
(43) Pub. Date: Apr. 14, 2011

(54) GUIDE RAIL FOR A POWER TOOL

(76) Inventors: Li Xing, (US); Yun Huang, (US)

(21) Appl. No.: 12/902,317

(22) Filed: Oct. 12, 2010

(30) Foreign Application Priority Data
Oct. 12, 2009 (CN) 200920049322.X
Oct. 13, 2009 (CN) 200920049342.7

(51) Int. Cl. B27B 9/04

(52) U.S. Cl. 83/821

(57) ABSTRACT

The present invention relates to a guide rail for a power tool with an auxiliary guide component having a locating block and a main guide component. The guide rail has a fixing device to connect the auxiliary guide component to the main guide component. The locating block has a taper-tilted edge that may be connected to a corresponding edge of the fixing device. Using the tapered fitting, the main guide component and the auxiliary guide component can be quickly connected or disconnected to adjust the positions of the auxiliary guide component and the main guide component during operation. The present invention may further include angle-indication marks. By setting the angle-indication marks on the auxiliary guide component, cutting at a certain angle can be achieved quickly to improve the convenience and efficiency of operation by the user.

### CROSS-REFERENCE TO RELATED APPLICATIONS

This application claims priority to Chinese Application No. 200920049322.X, filed on Oct. 12, 2009 and Chinese Application No. 200920049342.7 filed on Oct. 13, 2009, which are hereby incorporated by reference.

### FEDERALLY SPONSORED RESEARCH OR DEVELOPMENT

Not Applicable.

### TECHNICAL FIELD

The present invention relates to a guide rail for a power tool.

### BACKGROUND OF THE INVENTION

Hand-held power tools, especially saws having circular saw blades, are difficult to use for cutting in a straight line unless the saw is being used by an experienced user. Further, cutting a smooth curve is difficult for even an experienced user without using a guide to assist the user.

In order to guide a hand-held saw, such as a circular saw, a reciprocating saw, a jig saw, a router, or the like, various guide or clamping apparatuses are known to those of ordinary skill in the art. Specifically, there are two primary guides known in the prior art, assembled type and integrated type. An assembled type of guide comprises a plurality of sectional guide plates of different lengths. The user may select guide plates of different lengths and assemble them together to create the desired guide. During shipment, the guide plate may be disassembled and packaged separately to reduce the size of package and decrease shipping costs. An integrated guide apparatus is an integrated member of a fixed length, which is usually made from an extruded aluminum material which provides a very high level of precision.

### SUMMARY OF THE INVENTION

The object of the present invention is to provide an assembled type of guide rail that may be assembled and disassembled quickly. To achieve this object, the guide rail of the present invention comprises first and second guide components. Each guide component has a first end with a tongue-shaped portion extending outwardly and a second end with a groove that is fittable with the tongue-shaped portion. One of the tongue-shaped portion or the groove is formed with ribs, and the other one has slots that can connect with the ribs. The guide rail is mounted to a locking device that may fix the first and the second guide components together when the tongue-shaped portion is inserted into the groove portion. The locking device comprises a hole formed on one component and a protrusion formed on the other component. Using the fitting between the ribs and the elongate slots and the fitting of the hole and protrusion, the guide components of the guide rail in the present invention can be assembled and disassembled quickly. It also allows for easier use by the user and for more convenient packing and shipping of the guide rail.

Another object of the present invention is to provide a guide rail that may achieve a fast connection between the auxiliary guide plate and the guide plate. To achieve this object, the guide rail of the present invention has an auxiliary guide component including a locating block and a main guide component including a groove that can receive the locating block. The guide rail further comprises a fixing device which can connect the auxiliary guide component to the main guide component. The locating block has a taper-tilted edge and the fixing device has a tapered surface which is fittable with the taper-tilted edge. Using the fitting between the tapered surface and the taper-tilted edge, the main guide component and the auxiliary guide component can be quickly locked together or separated from each other to quickly adjust the positional relationship between the auxiliary guide component and the main guide component during operation.

A further object of the present invention is to provide a guide rail containing an angle-indicating device to quickly determine the cutting angle of the power tool mounted on the guide rail during tilted cutting. To achieve this object, the guide rail of the present invention has an auxiliary guide component including a locating block and a main guide component including a groove which can receive the locating block. The locating block also has angle-indication marks. By setting the angle-indication marks on the auxiliary guide component, the angle of the cutting edge can be quickly determined to enhance the convenience and efficiency of the operation by the user.

### BRIEF DESCRIPTION OF THE DRAWINGS

The present invention will be further described in detail in combination with the accompanying drawings and embodiments.

FIG. 1 is an elevated view of a hand-held saw having a guide rail according to a preferred embodiment of the present invention;

FIG. 2 is a top view of the guide rail of FIG. 1, wherein a first guide plate and a second guide plate are disassembled from each other;

FIG. 3 is a top view of the guide rail of FIG. 1, wherein the first guide plate is connected to the second guide plate;

FIG. 4 is a top view of the guide rail of FIG. 1, having a fixing device between an auxiliary guide plate and the first guide plate;

FIG. 5 is a top view of the fixing device between the auxiliary guide plate and the first guide plate according to another embodiment of the present invention; and,

FIG. 6 is a sectional cutaway view of the fixing device shown in FIG. 5.

### DETAILED DESCRIPTION

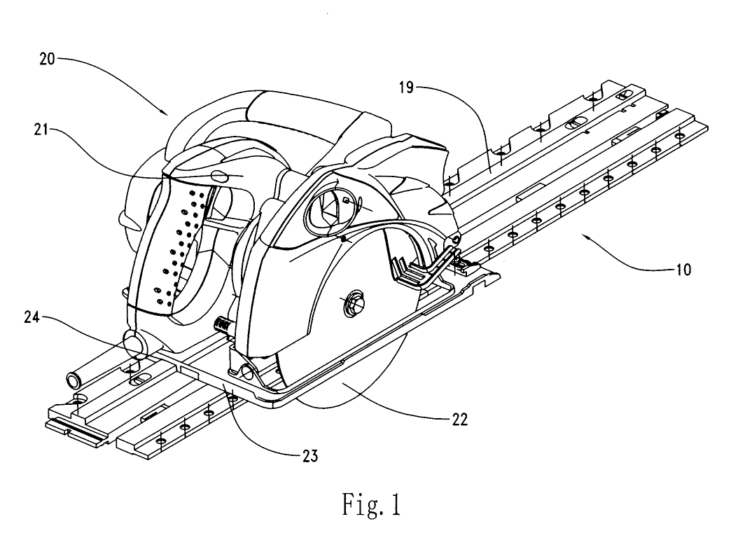

FIG. 1 shows a guide rail 10 according to a preferred embodiment of the invention, which can be used to guide a hand-held saw 20 mounted on the guide rail 10 to cut a workpiece along a straight line. In FIG. 1, a hand-held electrical circular saw is used as an example, however, the guide rail 10 can certainly be used together with other power tools such as electric routers, saber saws or jig saws. The hand-held electric circular saw 20 comprises a housing 21, a circular saw blade 22 mounted at least partially within the housing 21 and a bottom plate 23 pivotally connected to the housing. The bottom plate 23 has an elongate slot 24 arranged on a lower surface. The guide rail 10 also has a protruding ridge-shaped rib 19 on an upper surface. The ridge-shaped rib 19 is adapted to fit with the elongate slot 24 so as to mount the electric circular saw 20 onto the guide rail 10, so that the electric circular saw 20 can be moved to slide on the guide rail 10 along the ridge-shaped rib 19.

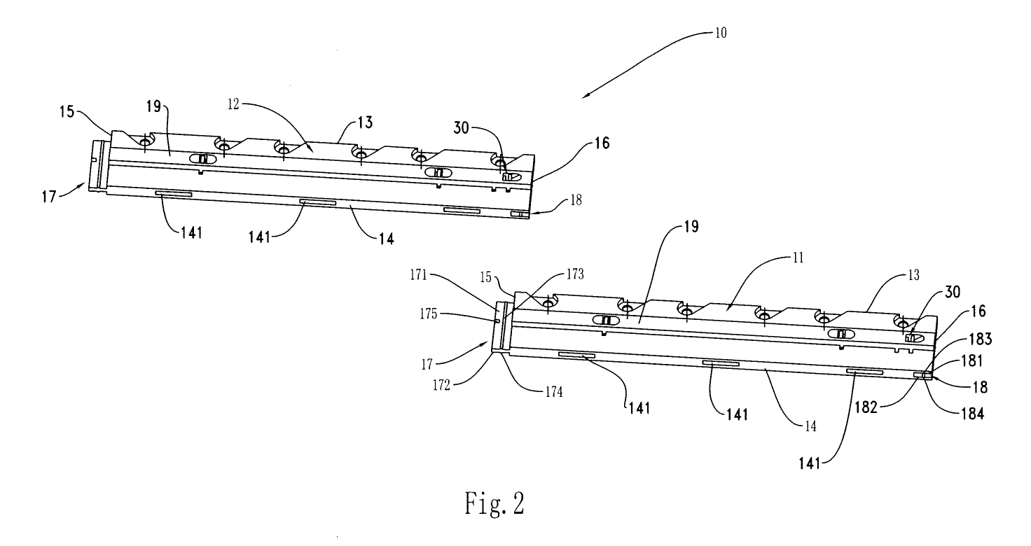

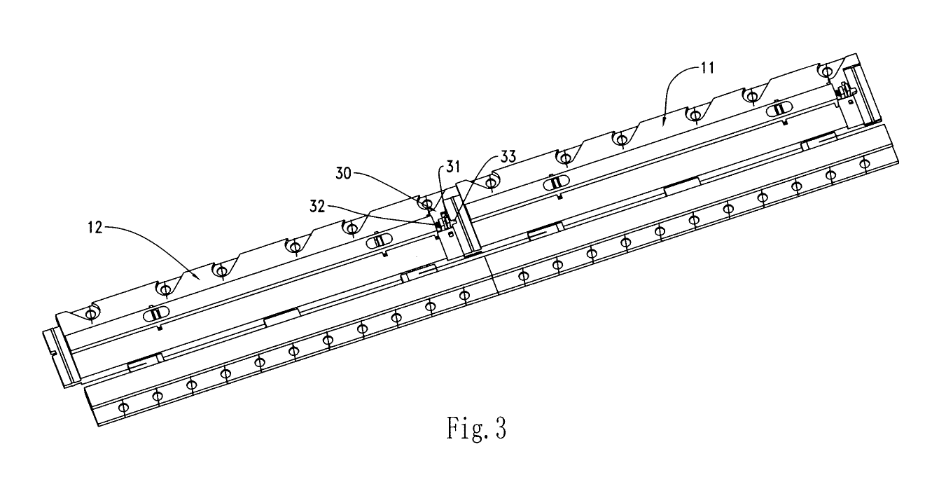

As shown in FIGS. 2 and 3, the guide rail 10 according to the invention is composed of a pair of elongate guide plates 11 and 12. Since the structure of guide plate 11 is the same as that of guide plate 12, only the structure of guide plate 11 will be described. Guide plate 11 is substantially rectangular and comprises a pair of long sides 13 and 14 and two ends 15 and 16. End 15 has a tongue-shaped portion 17 extending outwardly, which comprises an upper tapered surface 171 and a lower tapered surface 172 which have an inclination. End 15 also has an upward rib-shaped strip 173 which is formed on the upper tapered surface, and a downward rib-shaped strip 174 which is formed on the lower tapered surface parallel to the ends 15 and 16. Moreover, a notch 175 is formed on an outer edge of the tongue-shaped portion 17. End 16 is formed thereon inwardly with a groove 18 that is adapted to fit with the tongue-shaped portion 17. Groove 18 has an upper tapered surface 181 and lower tapered surface 182 which are adapted to fit with the upper tapered surface 171 and the lower tapered surface 172 of the tongue-shaped portion, respectively. Correspondingly, the tapered surfaces 181 and 182 are formed with elongate slots 183 and 184 fittable with the rib-shaped strips 173 and 174. One of ordinary skill in the art will understand that it is also possible that the rib-shaped strips protruding from the tapered surface are formed on the tapered surfaces 181 and 182 of the groove 18, and the elongate slots fittable with the rib-shaped strips are formed on the upper tapered surface 171 and the lower tapered surface 172 of the tongue-shaped portion. In the preferred embodiment, guide plates 11 and 12 are assembled together by inserting the tongue-shaped portion 17 of guide plate 11 into the groove 18 of guide plate 12, or inserting the tongue-shaped portion 17 of guide plate 12 into the groove 18 of guide plate 11. A locking device 30 is further arranged on each of the guide plates 11 and 12 for fixedly connecting the assembled guide plates 11 and 12 together. In the preferred embodiment, the locking device 30 is assembled on the guide plate near the groove 18 and comprises a switch 31, a spring 32 and a tapered pin 33, wherein the tapered pin 33 is fittable with the notch 175 of the tongue-shaped portion 17 and the elastic force of the spring 32 pushes the tapered pin 33 to move toward the notch 175. When assembling, the elastic force of the spring 32 is overcome and the switch 31 is pushed backwardly, so the tapered pin 33 is moved opposite to the notch 175. After the tapered pin 33 is completely moved out of the notch 175, the tongue-shaped portion 17 of guide plate 11 is inserted into the groove 18 of guide plate 12 and then the switch 31 is released so that the tapered pin 33 moves into the notch 175 under the elastic force of the spring 32 to lock the guide plates 11 and 12 together. Certainly, one of ordinary skill in the art could also easily appreciate that the assembling and locking between the guide plates 11 and 12 can be achieved by a fitting between a protrusion and a hole wherein the hole is formed on the tongue-shaped portion 17 of one of the guide plates and the protrusion protruding from the tapered surface of the groove is formed in the groove 18 of the other guide plate. Furthermore, the assembling and locking between the guide plates can also be achieved by arranging a protrusion protruding from the tapered surface on the tongue-shaped portion 17 of one guide plate and arranging a hole in the groove 18 of the other guide plate.

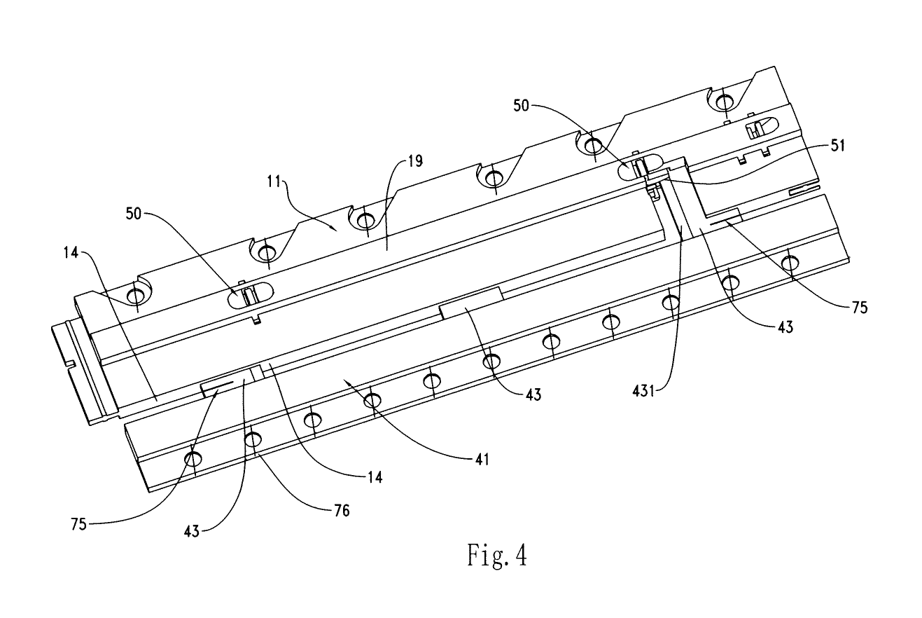

Referring to FIGS. 2 and 4, the guide rail 10 of the current invention further comprises an auxiliary guide plate 41 which is connectable with guide plates 11 and 12, and whose position relative to the guide plates 11 and 12 is adjustable. Since the connection methods between the auxiliary guide plate 41 and the guide plates 11 and 12 are the same, only guide plate 11 will be explained in detail. The side 14 of guide plate 11 has a plurality of long grooves 141. One side of the auxiliary guide plate 41 includes a plurality of locating blocks 43 that may be inserted into and connected to the long groove 141. Each locating block 43 includes a taper-tilted edge 431. The guide plate 11 is also mounted with a plurality of fixing devices 50 at the position corresponding to the long grooves 141, which may fixedly connect the auxiliary guide plate 41 to the guide plate 11. The fixing device 50 is a slidable block having a tapered surface 51 which is fittable with the taper-tilted edge 431. By moving the slidable block 50 towards the locating block 43, the tapered surface 51 of the slidable block 50 engages the taper-tilted edge 431 of the locating block 43, so that locking between the auxiliary guide plate 41 and the guide plate 11 may be achieved. Correspondingly, by moving the slidable block 50 in the opposite direction, the tapered surface 51 of the slidable block 50 will be separated from the taper-tilted edge 431 of the locating block 43, so that the auxiliary guide plate 41 will be released from the guide plate 11. The user can easily adjust the position of the auxiliary guide plate 41 relative to the guide plates 11 and 12 and can quickly lock the saw in a selected position.

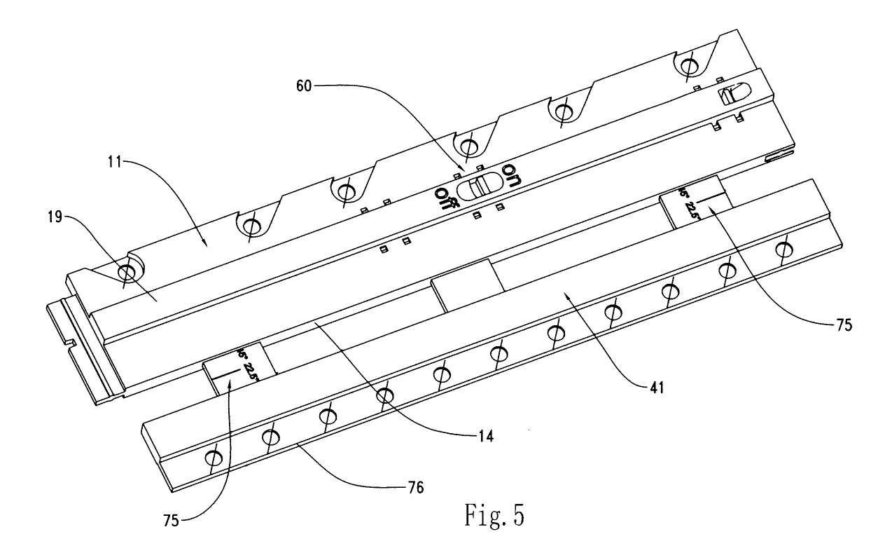

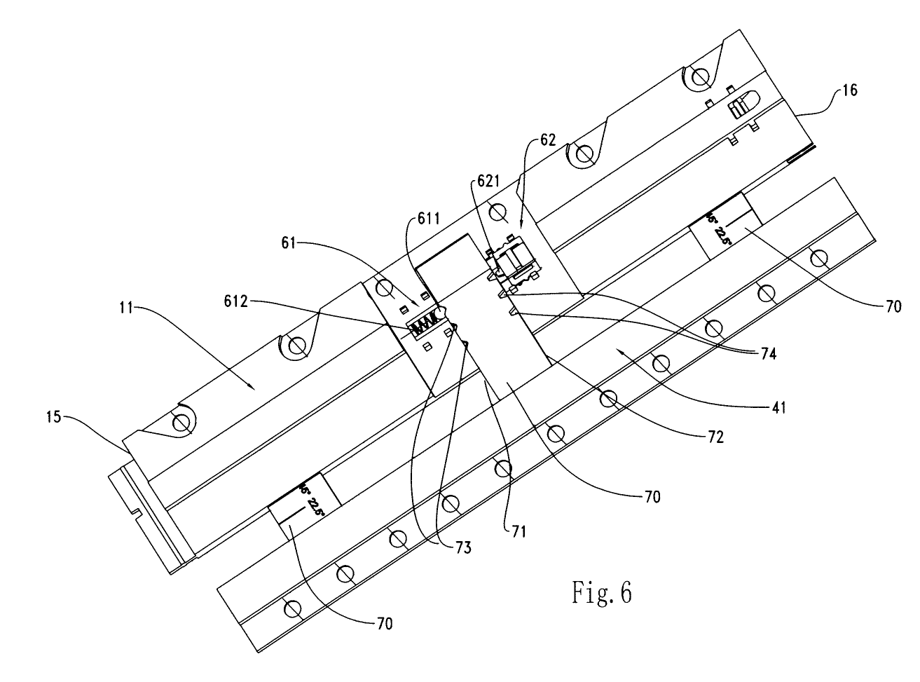

FIGS. 5 and 6 illustrate another embodiment of the fixing device between the guide plate 11 and the auxiliary guide plate 41. The fixing device 60 comprises a locating component 61 and a locking component 62 mounted on the guide plate 11. The locating component 61 includes a steel ball 611 and a spring 612, wherein the locking component 62 is a switch containing a tapered pin 621 on its front end. A locating block 70 has two parallel sides 71 and 72 that are parallel to the ends 15 and 16 of the guide plate 11. When the auxiliary guide plate 41 is connected to the guide plate 11, one side 71 of the locating block is closely adjacent to the locating component 61 and the other side 72 is closely adjacent to the locking component 62. Side 71 is arranged thereon with a plurality of notches 73 spaced from each other with a certain pitch. Side 72 is arranged thereon with a plurality of tapered notches 74 fitted with the tapered pins 621, and the place of each of tapered notches corresponds to each of the notches 73. During operation, the tapered pin 621 is moved out from the tapered notch 74, and then the auxiliary guide plate 41 is moved with respect of the guide plate 11 along a direction perpendicular to the longitudinal direction of the guide plate 11. Steel ball 611 will be pressed into the corresponding notch 73 under the elastic force of the spring 612. After the steel ball 611 is pressed into the notch 73 corresponding to the desired position, switch 62 will be pushed so that the tapered pin 621 will be moved into the tapered notch 74 under the driving of the switch, so as to achieve the connection between the auxiliary guide plate 41 and the guide plate 11.

According to the invention, locating blocks 43 and 70 can be further arranged with scale-indication marks 75 thereon. The scale-indication marks 75 are angle-indication marks, such as 0°, 22.5° and 45°. For example, when the electric circular saw is needed for tilted cutting at 45°, the auxiliary guide plate 41 could be moved by the user relative to the guide plates 11 and 12, so as to have the sides 14 of the guide plates 11 and 12 align with the scale-indication mark 45°. Then the auxiliary guide plate 41 may be fixed to the guide plates 11 and 12 at the corresponding position. As a result, saw blade 22 can perform the tilted cutting of 45° under the guide of the edge 76 of the auxiliary guide plate 41. Here, the scale-indication marks are determined according to the different distances from the intersected line of the saw blade 22 and the edge 76 to the ridge-shaped rib 19 when the electric circular saw performs the tilted cutting at different angles. When the tilted cutting angle of the electric circular saw is changed, the distance from the intersected line of the saw blade 22 and the edge 76 to the ridge-shaped rib 19 will be changed accordingly. Based on the changed distance, the corresponding tilted cutting angle can be set on the locating block 70. The positional relationship between the auxiliary guide plate and the guide plate may be adjusted according to the scale-indication mark 75, so as to implement the quick locating of the tilted cutting at a certain angle.

The above-mentioned embodiments only describe the conception and the principle of the present invention without limitation to the contents of the invention. One skilled in the art could realize that the present invention has additional equivalent embodiments and obvious modifications which are still included in the scope of the present invention defined by the appended claims.

What is claimed is:

1. A guide rail for a power tool, comprising:
an auxiliary guide component having a locating block; and
a main guide component having a groove to receive the locating block therein,
wherein the guide rail further comprises a fixing device to fixedly couple the auxiliary guide component to the main guide component.

2. The guide rail for a power tool according to claim 1, wherein the locating block has a tapered edge.

3. The guide rail for a power tool according to claim 2, wherein the fixing device has a tapered surface to be coupled to the tapered edge of the locating block.

4. The guide rail for a power tool according to claim 1, wherein the fixing device is a slidable block.

5. The guide rail for a power tool according to claim 1, wherein the locating block is arranged with angle-indication marks.

6. The guide rail for a power tool according to claim 1, wherein the fixing device comprises a locating component and a locking component.

7. The guide rail for a power tool according to claim 6, wherein the locating block has a first side adjacent to the locating component, and a second side adjacent to the locking component.

8. The guide rail for a power tool according to claim 7, wherein the second side of the locating block has a tapered notch.

9. The guide rail for a power tool according to claim 6, wherein the locating component comprises a steel ball and an elastic component acting on the steel ball.

10. The guide rail for a power tool according to claim 8, wherein the locking component is a switch, the switch having a tapered pin fitting with the tapered notch of the second side of the locating block.

11. A guide rail for a power tool, comprising:
an auxiliary guide component including a locating block; and
a main guide component including a groove that can receive the locating block therein, wherein the locating block is formed with angle-indication marks thereon.

12. The guide rail for a power tool according to claim 11, wherein the angle-indication marks include 0°, 22.5° and 45°.

13. The guide rail for a power tool according to claim 11, wherein the guide rail further has a ridge-shaped rib which can guide the power tool to move on the guide rail.

14. The guide rail for a power tool according to claim 11, wherein the auxiliary guide component has an edge which can guide the blade of the power tool.

15. The guide rail for a power tool according to claim 13, wherein each distance between the ridge-shaped ribs and the edge corresponds to each of the angle-indication marks.
